(19) United States
(12) Patent Application Publication
(10) Pub. No.: US 2009/0095547 A1
(43) Pub. Date: Apr. 16, 2009

(54) Motorized Personal Mobility Transportation Device for Outdoor Recreational Access

(76) Inventors: John C. Swett, Winder, GA (US); Tomas M. Swett, Panama City Beach, FL (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(21) Appl. No.: 12/251,524

(22) Filed: Oct. 15, 2008

Related U.S. Application Data
(60) Provisional application No. 60/980,233, filed on Oct. 16, 2007.

(51) Int. Cl. B60K 1/00

(52) U.S. Cl. 180/65.1

(57) ABSTRACT

A personal mobility transportation device is adapted for outdoor recreational use by a user. The device includes an aluminum frame employing non-corrosive fasteners. Four wheels, mounted on the frame, each includes a turf tire that is configured to operate in dry sand when loaded with at least 200 lbs. A seat includes a marine-quality weather-resistant foam. An electric transaxle motor drives the device. A marine-quality weather sealed battery supplies power to the electric transaxle motor. All controls necessary to control the device are mounted at the top of a steering column, thereby allowing control of the device without any inputs from the user's feet.

### CROSS-REFERENCE TO RELATED APPLICATION(S)

This application claims the benefit of U.S. Provisional Patent Application Ser. No. 60/980,233, filed Oct. 16, 2007, the entirety of which is hereby incorporated herein by reference.

### BACKGROUND OF THE INVENTION

1. Field of the Invention

The present invention relates to personal mobility transportation devices and, more specifically, to a personal mobility transportation device that facilitates access to outdoor recreational venues.

2. Description of the Prior Art

Many handicapped individuals and people who otherwise have difficulty walking enjoy outdoor activities, such as going to the beach or going along trails in the woods. However, enjoying such outdoor activities is often not possible without considerable help from non-handicapped assistants. It is especially difficult, for example, to move most wheelchairs or personal mobility scooters through dry sand.

Personal mobility transportation devices, such as motorized wheel chairs and personal mobility scooters, have existed for years to assist people who have difficulty walking. Such devices work well indoors, but have several shortcomings that prevent their use in many outdoor environments, such as at beaches and in muddy areas. Typically, such devices use relatively thin wheels, which makes them unusable in a sandy beach environment. They also tend to have a relatively high center of gravity, which makes them prone to tipping and, therefore, they cannot be used on sand dunes.

Golf carts are designed for outdoor use. However, a golf cart is not well suited for people who have difficulty walking because the controls for a golf cart are usually floor-mounted pedals that require foot pressure. Also, golf carts are not well adapted for such activities as climbing sand dunes at a beach. Also, golf carts tend to be too wide to pass through doors inside houses and, therefore, cannot be used indoors. Also golf carts, because their seats are higher than seats of power wheel chairs and mobility scooters, do not allow a user to transfer to and from a power wheel chair or mobility scooters to a golf cart.

While all terrain vehicles (ATVs) are sometimes used on beaches, they cannot be used by people who have diminished use of their legs because they employ foot controls to operate the devices and they require use of the legs to maintain position on the ATV.

Generally, existing personal mobility transportation devices and golf carts do not hold up well in a beach environment. This is because many of their parts are easily corroded or degraded by salt water spray and because their moving parts can be degraded by exposure to sand.

Therefore, there is a need for a personal mobility transportation device that is adapted for outdoor recreational use and that can be used indoors.

There is also a need for a personal mobility transportation device that helps people with limited mobility to access recreational venues, such as the beach.

### SUMMARY OF THE INVENTION

The disadvantages of the prior art are overcome by the present invention which, in one aspect, is a personal mobility transportation device adapted for outdoor recreational use by a user that includes an aluminum frame employing non-corrosive fasteners. Four wheels, including a pair of front wheels and a pair of rear wheels, are mounted on the frame. Each of the four wheels includes a turf tire that is configured to operate in dry sand when loaded with at least 200 lbs. so that the four wheels are configured to operate in dry sand while supporting at least 800 lbs. A seat is disposed on the frame and is configured to support at least one user sitting thereon. The seat includes a marine-quality weather-resistant foam. An electric transaxle motor is mounted on the frame and configured to drive at least a selected one of the pair of front wheels and the pair of rear wheels. A marine-quality weather sealed battery is mounted on the frame and is configured to supply power to the electric transaxle motor. A marine-quality weather sealed battery charger is configured to charge the battery. A steering column extends upwardly from a forward portion of the frame. The steering column has a top end at which is disposed a steering input control that is configured to receive direction control input from the user. The steering column is also configured to transmit the direction control input from the steering input control to the pair of front wheels. The top end of the steering column is coupled to a weather-sealed potentiometer that is configured to provide speed control input to the motor. A weather sealed control panel is disposed adjacent to the top end of the steering column. The control panel has disposed thereon a plurality of user control inputs and indicators, including: an on/off switch. The user control inputs and the steering input control are disposed so that the personal mobility transportation device is controllable exclusively from inputs from the user's hands, without requiring any input from feet of the user. The frame, the four wheels, the seat, the motor and the steering column are all disposed so that the personal mobility transportation device has a center of mass when a weight of up to 550 lbs. is disposed on the seat so that the personal mobility transportation device resists tipping when at an incline angle of at least 14° and when at a side load angle of at least 6°.

In another aspect, the invention is a personal mobility outdoors transportation device adapted for outdoor recreational use by a user that includes an aluminum frame employing stainless steel fasteners. A corrosion-resistant finish is applied to at least a portion of the frame. Four wheels, including a pair of front wheels and a pair of rear wheels, are mounted on the frame. Each of the four wheels includes a turf tire that is at least six inches wide and that is configured to operate in dry sand when loaded with at least 200 lbs. so that the four wheels are configured to operate in dry sand while supporting at least 800 lbs. Each of four fenders is disposed over a selected one of the four wheels and is configured to prevent sand from the tires from spraying onto user. A seat is disposed on the frame and is configured to support at least one user sitting thereon. The seat includes a marine-quality weather-resistant foam and is upholstered with a weather-resistant fabric. An electric transaxle motor is mounted on the frame and is configured to drive at least a selected one of the pair of front wheels and the pair of rear wheels. A marine-quality weather sealed battery is configured to supply power to the electric transaxle motor. A marine-quality weather sealed battery charger is configured to charge the battery. A steering column extends upwardly from a forward portion of the frame. The steering column has a top end at which is disposed a handlebar that is configured to receive direction control input from the user. The steering column is configured to transmit the direction control input from the handlebar to the pair of front wheels. The handlebar is coupled to a weather-sealed potentiometer that is configured to provide speed control input to the motor. A weather sealed control panel is disposed adjacent to the top end of the steering column. The control panel has disposed thereon a plurality of user control inputs and indicators, including: an on/off switch. The user control inputs and the handlebar disposed so that the personal mobility transportation device is controllable exclusively from inputs from the hands of the user, without requiring any input from feet of the user. The frame, the four wheels, the seat, the motor and the steering column are all disposed so that the personal mobility transportation device has a center of mass when a weight of up to 550 lbs. is disposed on the seat so that the personal mobility transportation device resists tipping when at an incline angle of at least 14° and when at a side load angle of at least 6°. The personal mobility transportation device is not wider than 34″.

In yet another aspect, the invention is a personal mobility recreational transportation device adapted for outdoor recreational use by a user. An aluminum frame employs non-corrosive fasteners and a corrosion-resistant finish is applied to the aluminum frame. Four wheels, including a pair of front wheels and a pair of rear wheels, are mounted on the frame. Each of the four wheels includes a turf tire that is at least 6″ wide and that is configured to operate in dry sand when loaded with at least 200 lbs. so that the four wheels are configured to operate in dry sand while supporting at least 800 lbs. The frame and the wheels together have a width that is not wider than 34″. An electric transaxle motor is mounted on the frame and is configured to drive at least a selected one of the pair of front wheels and the pair of rear wheels. A marine-quality weather sealed battery is configured to supply power to the electric transaxle motor. A steering input control is configured to receive direction control input from the user. A steering column extends upwardly from a forward portion of the frame. The steering column is configured to transmit the direction control input from the steering input control to the pair of front wheels. A weather sealed control panel is disposed adjacent to the top end of the steering column. The control panel has disposed thereon a plurality of user control inputs and indicators, including: an on/off switch.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a side elevational view of a first embodiment of a personal mobility device for recreational use.

FIG. 1B is a front elevational view of the embodiment shown in FIG. 1A.

FIG. 2 is a plan view of a control input.

FIG. 3 is a cross-sectional view of a portion of a seat employed in a personal mobility device.

FIG. 4 is a plan view of a frame employed in a personal mobility device with the body removed.

FIG. 5A is a side elevational view of a personal mobility device on an incline.

FIG. 5B is a side elevational view of a personal mobility device on a side load angle.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

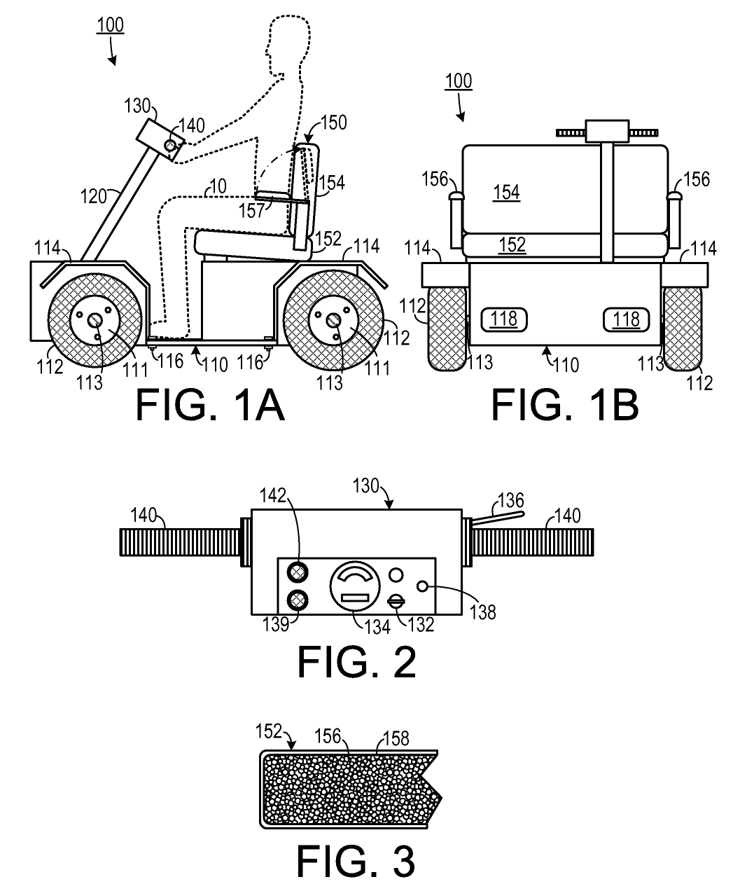

As shown in FIGS. 1A-1B, one embodiment of a personal mobility transportation device 100 is adapted for outdoor recreational use (such as at the beach) by a user 10. The device 100 includes an aluminum frame 110 employing stainless steel (or other non-corrosive) fasteners 116. Use of aluminum in the frame 110 makes the device 100 lighter, minimizes corrosion that could occur as a result of contact with sea water and the like and dissipates heat quickly. The aluminum frame also lightens the load and facilitates transport of the device 100. The frame 110 is coated with a weather-resistant coating, such as paint or powder coat to reduce corrosion. Given its typical use at the beach, a lighter color will improve heat reflection.

Four wheels 111, including a pair of front wheels and a pair of rear wheels, are mounted on the frame 110 via an axle 113. Each of the four wheels 111 includes a pneumatic turf tire 112 configured for use on dry sand. Typically, each tire 112 is at least 6″ wide (8″ wide in one embodiment) so that each wheel 111 can operate in dry sand while supporting up to 200 lbs. (or more), thereby allowing a total loaded operation weight of at least 800 lbs. Disposed over each wheel 111 is a fender 114 that prevents sand from being kicked up onto the user 10 during operation of the device 100. A pair of headlights 118 may be disposed at the front end of the frame 110.

A steering column 120 extends upwardly from a forward portion of the frame 110. A steering input control, such as a handlebar 140 is disposed at the top of the steering column 120. (In another embodiment, the steering input control could be a joystick.) The steering column 120 transmits steering control to the front wheels 111.

As shown in FIG. 2, a weather sealed, water resistant instrument panel 130, is disposed adjacent to the top end of the steering column 120 and is integrated with the handlebar 140. The control panel 130 includes a plurality of user control inputs and indicators. For example, the control panel 130 could include: an on/off switch 132; a light switch 138; a horn switch 139, a gauge 134 which can show such information as battery charge state, hours used, etc.; a speed limiting potentiometer 142 that acts as a governor that controls the maximum speed of the device 100; a forward-reverse throttle lever 136; and other controls as needed.

Returning to FIG. 1, a seat 150 is disposed on the frame 110 and includes a seat portion 152, a backrest portion 154 and two retractable armrest portions 157. The armrests 157 can be retracted into an upright position to enable the user to transfer more easily from a power wheelchair to the device 100 and back. Also, the height of the seat 152 from the ground is preferably close to the height of the seat of a motorized wheelchair from the ground, also to facilitate easy transfer of the user back and forth.

As shown in FIG. 3, the seat 150 employs a marine-quality weather-resistant closed cell foam 156 that does not absorb water. The seat 150 is upholstered with a weather-resistant fabric 158, such as fabric used to upholster boat furniture and patio furniture. Given that one embodiment of the device 100 is intended to be usable at the beach, using a lighter color for the weather-resistant fabric 158 will cause more light to be reflected and, therefore, make the seat more comfortable on hot days. In one embodiment, the device 100 can be configured with a two-person seat.

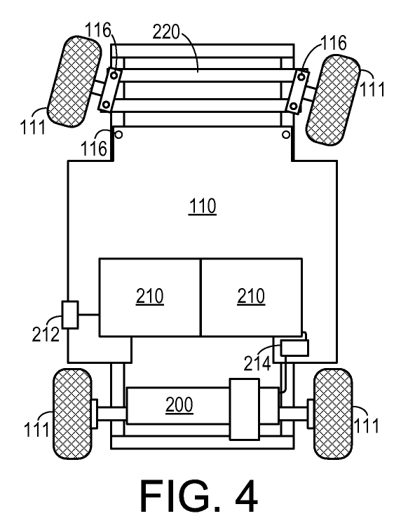

As shown in FIG. 4, an electric transaxle high torque motor 200 is mounted on the frame 110 and drives the front pair of wheels 111. (It should be understood that both front wheel drive and a four wheel drive embodiments are employable with the invention.) In one embodiment, the transaxle has a gear ratio in the range of about 24.99 to 32.39. The motor 200 is powered by marine-quality weather sealed batteries 210, such as two 12V sealed gelled-electrolyte batteries (which results in a 24V system—as would be understood by those of skill in the art, other embodiments are possible, including a 36V system). An 80 amp breaker (not shown) in the electrical system limits current to the motor. A motor control unit 214 receives input from the control panel (item 130 in FIG. 1A) to control the speed of the motor 200. A marine-quality weather sealed battery charger 212 is used to recharge the batteries 210. In one embodiment, designed for compliance with Federal powered wheelchair standards, the motor 200 is governed to limit forward velocity of the device 100 to no more than 6.0 mph.

In one embodiment, the motor 200 is rated at about 830 W and the control panel is rated at no less than 140 Amps so as to be able to handle power surges from the motor 200. Thus, when the batteries 210 are fully charged, the device 100 will have a range of at least 18 miles.

A front end steering unit 220 includes is coupled to the steering column via a pari of tie rods (not shown) or to an electrical steering unit to transmit steering input to the wheels 111. Thus steering control can be accomplished via either a mechanical linkage to the steering column or an electro-mechanical steering control device that receives a steering signal input from an electronic steering control unit (such as a joystick).

The placement of the steering and speed controls are disposed so that the user is not required to use his or her feet in controlling the device. Thus, the device is particularly useful for allowing those with no or limited foot and leg mobility to access such outdoor venues as the beach.

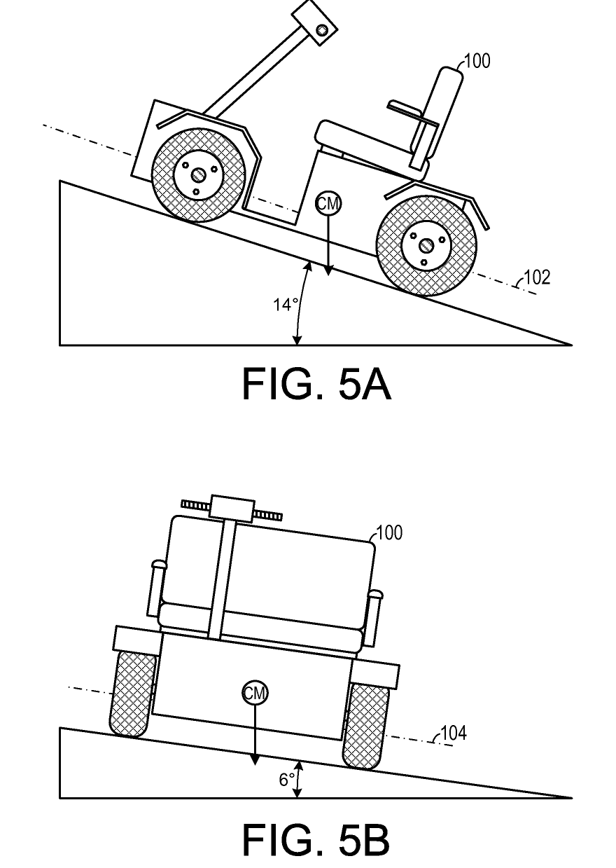

As shown in FIG. 5A and 5B, the device 100 is designed so that it has a center of mass (CM) when supporting a user or users with a total weight of up to 550 lbs. that prevents tipping when at an incline angle (an angle between the forward axis 102 of the device 100 and the horizon) is at least 14° (and preferably as much as 25° or more). The disposition of the components of the device 100 should also prevent tipping when the side load angle (the angle between the side-to-side axis 104 of the device 100 and the horizon) is at least 6° (and preferably as much as 8° or more). This resistance to tipping allows use of the device 100 on sand dunes and the like.

In one embodiment, the scooter has a longer wheelbase and is somewhat wider than a typical personal mobility scooter, thereby reducing the likelihood of tipping while climbing hills and sand dunes. It also employs standard turf tires to allow it to negotiate sand, mud and the like better. In one configuration, the tires are 18×8½ in the rear and 14×8¾ in the front. The scooter includes fenders about the wheels to prevent the kicking up of sand.

In one embodiment, the personal mobility transportation device 100 is not wider than 34″. This allows the user to pass through a standard 35″ door jam, which can allow the user to visit the beach and also enter beach dwellings and restaurants during visits to the beach. Because of its width, the device 100 can be classified as a wheelchair.

In one embodiment, the scooter is powered by a battery-powered electric motor that has four times the torque of a traditional scooter. A transaxle improves response to sand. In one embodiment, a selective positraction capability can be added, which would apply positraction when a button is pressed by a user.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A personal mobility transportation device adapted for outdoor recreational use by a user, comprising:
a. an aluminum frame employing non-corrosive fasteners;
b. four wheels, including a pair of front wheels and a pair of rear wheels, mounted on the frame, each of the four wheels including a turf tire that is configured to operate in dry sand when loaded with at least 200 lbs. so that the four wheels are configured to operate in dry sand while supporting at least 800 lbs.;
c. a seat disposed on the frame and configured to support at least one user sitting thereon, the seat including a marine-quality weather-resistant closed cell foam;
d. an electric transaxle motor mounted on the frame and configured to drive at least a selected one of the pair of front wheels and the pair of rear wheels;
e. a marine-quality weather sealed battery mounted on the frame and configured to supply power to the electric transaxle motor;
f. a marine-quality weather sealed battery charger configured to charge the battery;
g. a steering column extending upwardly from a forward portion of the frame, the steering column having a top end at which is disposed a steering input control that is configured to receive direction control input from the user and the steering column configured to transmit the direction control input from the steering input control to the pair of front wheels, the top end of the steering column coupled to a weather-sealed potentiometer that is configured to provide speed control input to the motor; and
h. a weather sealed control panel disposed adjacent to the top end of the steering column, the control panel having disposed thereon a plurality of user control inputs and indicators, including: an on/off switch,
the user control inputs and the steering input control disposed so that the personal mobility transportation device is controllable exclusively from inputs from the user's hands, without requiring any input from feet of the user,
the frame, the four wheels, the seat, the motor and the steering column all disposed so that the personal mobility transportation device has a center of mass when a weight of up to 550 lbs. is disposed on the seat so that the personal mobility transportation device resists tipping when at an incline angle of at least 14° and when at a side load angle of at least 6°.

2. The personal mobility transportation device of claim 1, wherein the fasteners all comprise stainless steel fasteners.

3. The personal mobility transportation device of claim 1, wherein the steering input control comprises a selected one of a handlebar and a joystick.

4. The personal mobility transportation device of claim 1, further comprising a weather-resistant fabric used to upholster the seat.

5. The personal mobility transportation device of claim 1, further comprising a corrosion-resistant finish applied to at least a portion of the frame.

6. The personal mobility transportation device of claim 1, wherein each turf tire is at least 6 in. wide.

7. The personal mobility transportation device of claim 1, further comprising four fenders, each fender disposed over a selected one of the four wheels and configured to prevent sand from the tires from spraying onto user.

8. The personal mobility transportation device of claim 1, in which the personal mobility transportation device is not wider than 34″.

9. The personal mobility transportation device of claim 1, in which the motor is configured limit forward velocity of the personal mobility transportation device to no more than 6.0 mph.

10. The personal mobility transportation device of claim 1, in which the weather sealed control panel is rated at no less than 140 Amps.

11. A personal mobility outdoors transportation device adapted for outdoor recreational use by a user, comprising:
a. an aluminum frame employing stainless steel fasteners, a corrosion-resistant finish applied to at least a portion of the frame;
b. four wheels, including a pair of front wheels and a pair of rear wheels, mounted on the frame, each of the four wheels including a turf tire that is at least six inches wide and that is configured to operate in dry sand when loaded with at least 200 lbs. so that the four wheels are configured to operate in dry sand while supporting at least 800 lbs.;
c. four fenders, each fender disposed over a selected one of the four wheels and configured to prevent sand from the tires from spraying onto user;
d. a seat disposed on the frame and configured to support at least one user sitting thereon, the seat including a marine-quality weather-resistant foam and upholstered with a weather-resistant fabric;
e. an electric transaxle motor mounted on the frame and configured to drive at least a selected one of the pair of front wheels and the pair of rear wheels;
f. a marine-quality weather sealed battery configured to supply power to the electric transaxle motor;
g. a marine-quality weather sealed battery charger configured to charge the battery;
h. a steering column extending upwardly from a forward portion of the frame, the steering column having a top end at which is disposed a handlebar that is configured to receive direction control input from the user and the steering column configured to transmit the direction control input from the handlebar to the pair of front wheels, the handlebar coupled to a weather-sealed potentiometer that is configured to provide speed control input to the motor; and
i. a weather sealed control panel disposed adjacent to the top end of the steering column, the control panel having disposed thereon a plurality of user control inputs and indicators, including: an on/off switch,
the user control inputs and the handlebar disposed so that the personal mobility transportation device is controllable exclusively from inputs from the hands of the user, without requiring any input from feet of the user,
the frame, the four wheels, the seat, the motor and the steering column all disposed so that the personal mobility transportation device has a center of mass when a weight of up to 550 lbs. is disposed on the seat so that the personal mobility transportation device resists tipping when at an incline angle of at least 14° and when at a side load angle of at least 6°, the personal mobility transportation device being not wider than 34″.

12. The personal mobility outdoors transportation device of claim 11, in which the motor is configured limit forward velocity of the personal mobility transportation device to no more than 6.0 mph.

13. The personal mobility outdoors transportation device of claim 11, in which the weather sealed control panel is rated at no less than 140 Amps.

14. A personal mobility recreational transportation device adapted for outdoor recreational use by a user, comprising:
a. an aluminum frame employing non-corrosive fasteners, a corrosion-resistant finish applied to the aluminum frame;
b. four wheels, including a pair of front wheels and a pair of rear wheels, mounted on the frame, each of the four wheels including a turf tire that is at least 6″ wide and that is configured to operate in dry sand when loaded with at least 200 lbs. so that the four wheels are configured to operate in dry sand while supporting at least 800 lbs., the frame and the wheels together having a width that is not wider than 34″;
c. an electric transaxle motor mounted on the frame and configured to drive at least a selected one of the pair of front wheels and the pair of rear wheels;
d. a marine-quality weather sealed battery configured to supply power to the electric transaxle motor;
e. a steering input control that is configured to receive direction control input from the user;
f. a steering column extending upwardly from a forward portion of the frame, the steering column configured to transmit the direction control input from the steering input control to the pair of front wheels; and
g. a weather sealed control panel disposed adjacent to the top end of the steering column, the control panel having disposed thereon a plurality of user control inputs and indicators, including: an on/off switch.

15. The personal mobility recreational transportation device of claim 14, wherein the fasteners all comprise stainless steel fasteners.

16. The personal mobility recreational transportation device of claim 14, further comprising:
a. a seat disposed on the frame and configured to support at least one user sitting thereon, the seat including a marine-quality weather-resistant foam; and
b. a weather-resistant fabric used to upholster the seat.

17. The personal mobility recreational transportation device of claim 14, wherein the user control inputs and the handlebar are disposed so that the personal mobility transportation device is controllable exclusively from inputs from the hands of the user, without requiring any input from feet of the user.

18. The personal mobility transportation device of claim 14, wherein the frame, the four wheels, the seat, the motor and the steering column are all disposed so that the personal mobility transportation device has a center of mass when a weight of up to 550 lbs. is disposed on the seat so that the personal mobility transportation device resists tipping when at an incline angle of at least 14° and when at a side load angle of at least 6°.

19. The personal mobility recreational transportation device of claim 14, further comprising four fenders, each fender disposed over a selected one of the four wheels and configured to prevent sand from the tires from spraying onto user.

20. The personal mobility recreational transportation device of claim 14, further comprising a marine-quality weather sealed battery charger configured to charge the battery.
